(19) United States
(12) Patent Application Publication
(10) Pub. No.: US 2006/0139277 A1
(43) Pub. Date: Jun. 29, 2006

(54) Active matrix liquid crystal display with black image

(75) Inventors: Sz Hsiao Chen, Miao-Li (TW); Long Kuan Chen, Miao-Li (TW); Hung Yu Chen, Miao-Li (TW); Tsau Hua Hsieh, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/316,725

(22) Filed: Dec. 23, 2005

(30) Foreign Application Priority Data
Dec. 24, 2004 (TW) 93140469

(51) Int. Cl. G09G 3/36; H04N 5/66; H04N 3/14; H04N 9/12

(52) U.S. Cl. 345/92; 348/790; 348/739; 345/87

(57) ABSTRACT

An active matrix LCD (200) includes: a plurality of scanning lines (23) that are parallel to each other and that each extend along a first direction; a plurality of signal lines (24) that are parallel to each other and that each extend along a second direction orthogonal to the first direction; a plurality of thin film transistors (TFTs) each provided in the vicinity of a respective point of intersection of the scanning lines and the signal lines; a plurality of scanning line driving circuits (21) for providing a plurality of scanning signal groups to the scanning lines, each scanning signal group including an image scanning signal and a black-inserting scanning signal; a plurality of signal line driving circuits (22) for providing gradation voltage data to the signal lines; and a plurality of black-inserting circuits (28) for providing a high voltage corresponding to black image data to the signal lines.

### FIELD OF THE INVENTION

The present invention relates to liquid crystal displays (LCDs), and particular to an active matrix type LCD which is suitable for motion picture display.

### BACKGROUND

Because LCD devices have the advantages of portability, low power consumption, and low radiation, they have been widely used in various portable information products such as notebooks, personal digital assistants (PDAs), video cameras, and the like. Furthermore, LCD devices are considered by many to have the potential to completely replace CRT (cathode ray tube) monitors and televisions.

FIG. 3 is an abbreviated circuit diagram of a conventional active matrix LCD. The active matrix LCD 100 includes a glass first substrate (not shown), a glass second substrate (not shown) facing the first substrate, a liquid crystal layer (not shown) sandwiched between the first substrate and the second substrate, a plurality of scanning line driving circuits 11, a plurality of signal line driving circuits 12, and a timing control circuit 16.

The first substrate includes a number n (where n is a natural number) of scanning lines 13 that are parallel to each other and that each extend along a first direction, and a number m (where m is also a natural number) of signal lines 14 that are parallel to each other and that each extend along a second direction orthogonal to the first direction. The first substrate also includes a plurality of thin film transistors (TFTs) 15 that function as switching elements. The first substrate further includes a plurality of pixel electrodes 151 formed on a surface thereof facing the second substrate. Each TFT 15 is provided in the vicinity of a respective point of intersection of the scanning lines 13 and the signal lines 14.

Each TFT 15 includes a gate electrode, a source electrode, and a drain electrode. The gate electrode of each TFT 15 is connected to the corresponding scanning line 13. The source electrode of each TFT 15 is connected to the corresponding signal line 14. The drain electrode of each TFT 15 is connected to a corresponding pixel electrode 151.

The second substrate includes a plurality of common electrodes 152 opposite to the pixel electrodes 151. In particular, the common electrodes 152 are formed on a surface of the second substrate facing the first substrate, and are made from a transparent material such as ITO (Indium-Tin Oxide) or the like. A pixel electrode 151, a common electrode 152 facing the pixel electrode 151, and liquid crystal molecules of the liquid crystal layer sandwiched between the two electrodes 151, 152 cooperatively define a single pixel unit.

The scanning lines 13 are connected to a plurality of scanning line driving circuits 11. The signal lines 14 are connected to a plurality of a signal line driving circuits 12.

FIG. 4 is an abbreviated timing chart illustrating operation of the active matrix LCD 100. The clock signal and the start signal STV1 are generated by the timing control circuit 16. The scanning signals G1.1-Gn.256 are generated by the plurality of scanning line driving circuits 11, and are applied to the scanning lines 13. The enable signal for signal line driving circuit S1.OE-Sk.OE is used to select one of the signal line driving circuits 16 to be in an on state each time. The gradation voltage data VD are generated by the plurality of signal line driving circuits 12, and are sequentially applied to the signal lines 14. The common voltage Vcom is applied to all of the common electrodes 152. Only one scanning signal pulse 19 is applied to each scanning line 13 during each one scan, the scanning signal pulse 19 having a duration equal to one period of the clock pulses. The scanning signal pulses 19 are output sequentially to the scanning lines 13.

Referring to FIGS. 3 and 4, the scanning line driving circuits 11 sequentially provide scanning pulses (G1.1 to Gn.256) to the scanning lines 13, and activate the TFTs 15 respectively connected to the scanning lines 13. When the scanning lines 13 are thus scanned, the signal line driving circuits 12 output gradation voltage data (VD) corresponding with image data of an external circuit to the signal lines 13. Then the gradation voltage data are applied to the pixel electrodes 151 via the activated TFTs 15. The potentials of the common electrodes 152 are set at a uniform potential. The gradation voltage data written to the pixel electrodes 151 are used to control the amount of light transmission of the corresponding pixel units and consequently provide an image display for the active matrix LCD 100.

In FIG. 4, the signal of gradation voltage data VD is a signal whose strength varies in accordance with each piece of image data, whereas the signal of common voltage Vcom has a constant value that does not vary at all.

If motion picture display is conducted on the active matrix LCD 100, problems of poor image quality may occur. For example, the residual image phenomenon may occur because the response speed of the liquid crystal molecules is too slow. In particular, when a gradation variation occurs, the liquid crystal molecules are unable to track the gradation variation within a single frame period and produce a cumulative response during several frame periods. Consequently, considerable research is being conducted with a view to developing various high-speed response liquid crystal materials as a way of overcoming this problem.

Further, the aforementioned problems such as the residual image phenomenon are not caused solely by the response speed of the liquid crystal molecules. For example, when the displayed image is changed in each frame period (the period that the scanning line driving circuits 11 sequentially complete scanning from G1.1 to Gn.256 once) to display the motion picture, the displayed image of one frame period remains in a viewer's eyes as an afterimage, and this afterimage overlaps with the viewer's perception of the displayed image of the next frame period. This means that from the viewpoint of a user, the image quality of the displayed image is impaired.

It is desired to provide an active matrix LCD that can overcome the above-described deficiencies.

### SUMMARY

An active matrix liquid crystal display includes: a plurality of scanning lines that are parallel to each other and that each extend along a first direction; a plurality of signal lines that are parallel to each other and that each extend along a second direction that is orthogonal to the first direction; a plurality of thin film transistors (TFTs) each provided in the vicinity of a respective point of intersection of the scanning lines and the signal lines; a plurality of scanning line driving circuits for providing a plurality of scanning signal groups to the scanning lines, each of the scanning signal groups including an image scanning signal and a black-inserting scanning signal; a plurality of signal line driving circuits for providing gradation voltage data to the signal lines when an image scanning signal is provided to the scanning lines by the scanning line driving circuits; and a plurality of black-inserting circuits for providing a high voltage corresponding to black image data to the signal lines when a black-inserting scanning signal is provided to the scanning lines by the scanning line driving circuits.

The signal line driving circuits provide gradation voltage data corresponding with image data to the signal lines. In one embodiment, after about half of a corresponding frame time has elapsed, the black-inserting circuit provides a high voltage corresponding with black image data to the signal lines. With this mode of operation, a viewer's eyes perceive the black image during the second half of the frame time, and any afterimage of the image displayed in the first half of the frame time that would otherwise exist in the viewer's eyes is lost.

Other advantages and novel features will become more apparent from the following detailed description when taken in conjunction with the accompanying drawings, in which:

### BRIEF DESCRIPTION OF THE DRAWINGS

FIG. 1 is an abbreviated circuit diagram of an active matrix LCD according to an exemplary embodiment of the present invention;

FIG. 2 is an abbreviated timing chart illustrating operation of the active matrix LCD of FIG. 1;

FIG. 3 is an abbreviated circuit diagram of a conventional active matrix LCD; and

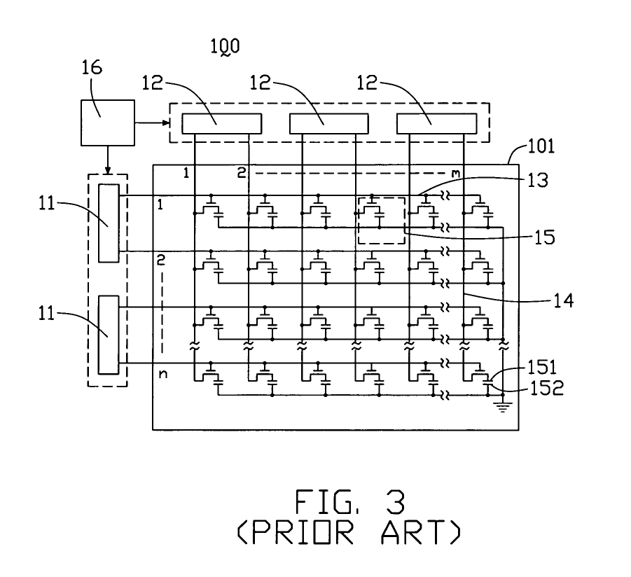

FIG. 4 is an abbreviated timing chart illustrating operation of the active matrix LCD of FIG. 3.

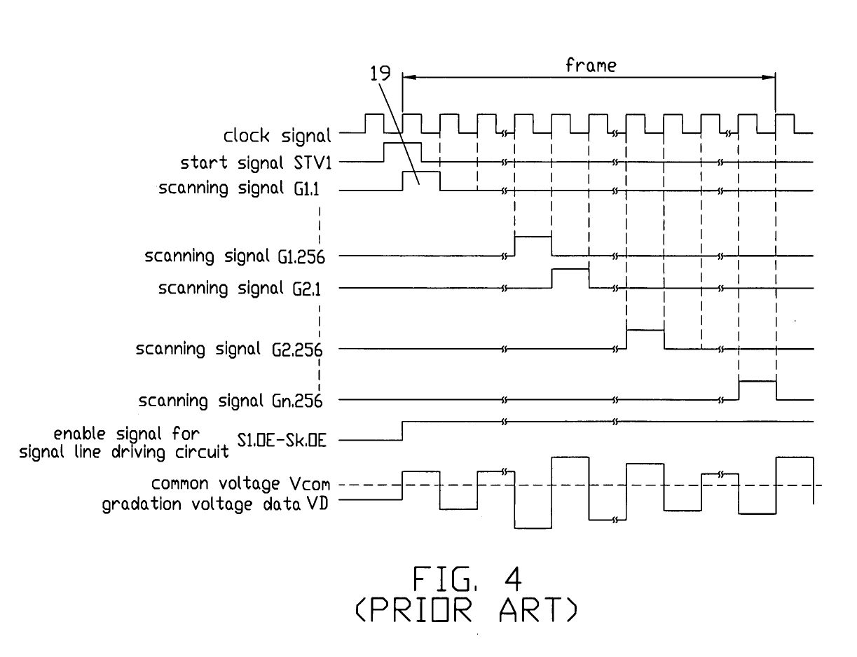

### DETAILED DESCRIPTION OF PREFERRED EMBODIMENTS

Reference will now be made to the drawings to describe the present invention in detail.

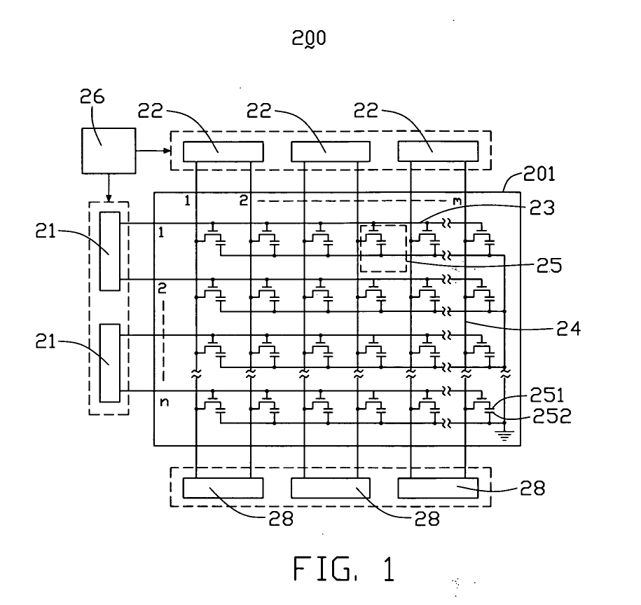

FIG. 1 is an abbreviated circuit diagram of an active matrix LCD according to an exemplary embodiment of the present invention. The active matrix LCD 200 includes a glass first substrate (not shown), a glass second substrate (not shown) facing the first substrate, a liquid crystal layer (not shown) sandwiched between the first substrate and the second substrate, a plurality of scanning line driving circuits 21, a plurality of signal line driving circuits 22, a plurality of black-inserting circuits 28, and a timing control circuit 26.

The first substrate includes a number n (where n is a natural number) of scanning lines 23 that are parallel to each other and that each extend along a first direction, and a number m (where m is also a natural number) of signal lines 24 that are parallel to each other and that each extend along a second direction orthogonal to the first direction. The first substrate also includes a plurality of TFTs (thin film transistors) 25 that function as switching elements. The first substrate further includes a plurality of pixel electrodes 251 formed on a surface thereof facing the second substrate. Each TFT 25 is provided in the vicinity of a respective point of intersection of the scanning lines 23 and the signal lines 24.

Each TFT 25 includes a gate electrode, a source electrode, and a drain electrode. The gate electrode of the TFT 25 is connected to the corresponding scanning line 23. The source electrode of the TFT 25 is connected to the corresponding signal line 24. The drain electrode of the TFT 25 is connected to a corresponding one of the pixel electrodes 251.

The second substrate includes a plurality of common electrodes 252 opposite to the pixel electrodes 251. In particular, the common electrodes 252 are formed on a surface of the second substrate that faces the first substrate, and are transparent electrodes made of ITO or the like. A pixel electrode 251, a common electrode 252 facing the pixel electrode 251, and liquid crystal molecules of the liquid crystal layer sandwiched between the two electrodes 251, 252 cooperatively define a single pixel unit.

The scanning lines 23 are connected to the scanning line driving circuits 21. The signal lines 24 are connected to the signal line driving circuits 22 and the black-inserting circuits 28.

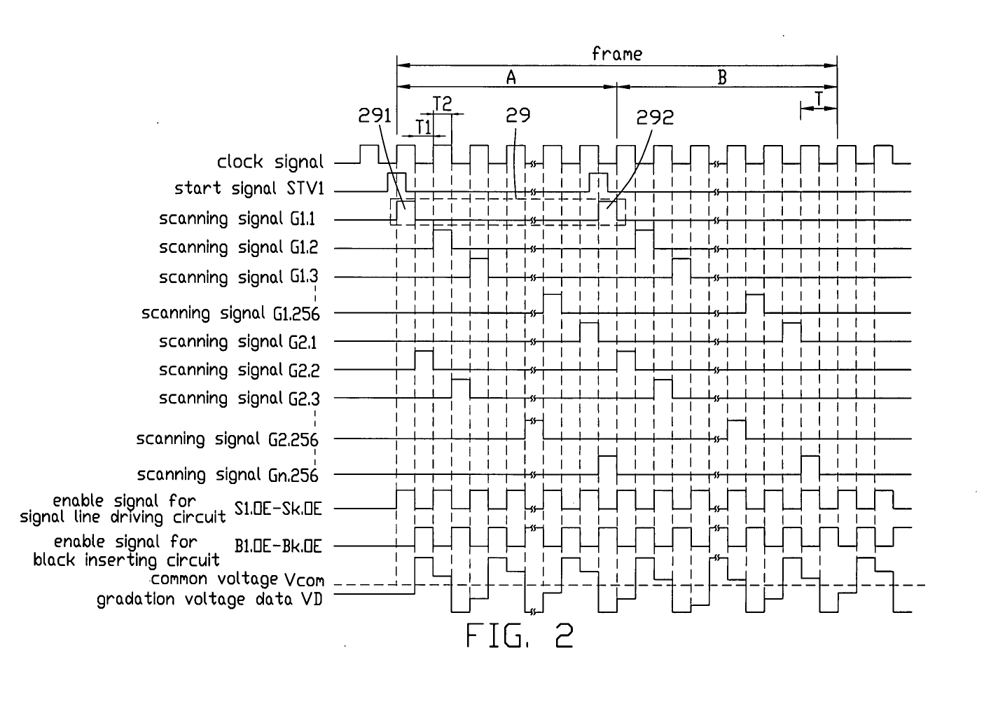

FIG. 2 is an abbreviated timing chart illustrating operation of the active matrix LCD 200. The clock signal and the start signal STV1 are generated by the timing control circuit 26, and the clock signal has a steady period T. The scanning signal groups G1.1-Gn.256 are generated by the plurality of scanning line driving circuits 21, and are applied to the scanning lines 23. The gradation voltage data VD are generated by the plurality of signal line driving circuits 22, and are sequentially applied to the signal lines 24. The common voltage Vcom is applied to all of the common electrodes 252. The enable signal for signal line driving circuit S1.OE-Sk.OE is used to select one of the signal line driving circuits 26 to be in an on state. The enable signal for black-inserting circuit B1.OE-Bk.OE is used to select one of the black-inserting circuits 28 to be in an on state each time. Only one of the scanning signal groups 29 is applied to each scanning line 23 during each one scan. The scanning signal groups 29 are output sequentially to the scanning lines 23. Each of the scanning signal groups 29 has a duration equal to a predetermined time, such as half of the frame time. Each of the signal groups 29 includes an image scanning signal 291 having a duration represented by a time period T1, and a black-inserting scanning signal 292 having a duration represented by a time period T2. T1 plus T2 is equal to the clock period T. Both the image scanning signal 291 and the black-inserting scanning signal 292 are pulse signals. In the illustrated embodiment, T1 is equal to T2.

The scanning line driving circuits 21 sequentially apply the scanning signal groups 29 (G1.1 to Gn.256) to the scanning lines 23. When the image scanning signals 291 are provided to the scanning lines 23 by the corresponding scanning line driving circuits 21, the TFTs 25 respectively connected to the scanning lines 23 are activated by the image scanning signals 291. Then the signal line driving circuits 22 provide gradation voltage data (VD) corresponding with image data of an external circuit to the signal lines 24, and the gradation voltage data are written to the pixel electrodes 251 via the activated TFTs 25. The potentials of the common electrodes 252 are set at a uniform potential. The gradation voltage data written to the pixel electrodes 251 are used to control the amount of light transmission of the corresponding pixel units and consequently provide an image display for the active matrix LCD 200. When the black-inserting scanning signals 292 are provided to the scanning lines 23 by the corresponding scanning line driving circuits 21, the TFTs 25 respectively connected to the scanning lines 23 are activated by the black-inserting scanning signals 292. Then the black-inserting circuits 28 provide a high voltage corresponding with black image data to the signal lines 24, and the black image data are written to the pixel electrodes 251 via the activated TFTs 25. The black image data written to the pixel electrodes 251 are used to control the amount of light transmission of the corresponding pixel units and consequently provide a black image display for the active matrix LCD 200.

Unlike with the above-described conventional active matrix LCD 100, the signal lines 24 of the active matrix LCD 200 are connected to the plurality of signal line driving circuits 22 and the plurality of black-inserting circuits 28. The signal line driving circuits 22 provide gradation voltage data corresponding with image data to the signal lines 24. After about half of the frame time, the black-inserting circuits 28 provide a high voltage corresponding with black image data to the signal lines 24. With this mode of operation, a viewer's eyes perceive the black image during the second half frame time B, and any afterimage of the image displayed in the first half frame time A that would otherwise exist in the viewer's eyes is lost. Accordingly, there is no afterimage that can overlap with the viewer's perception of the displayed image of the next frame period. This means that from the viewpoint of a user, the image quality of the displayed image is clear.

In alternative embodiments, for example, each of the scanning signal groups 29 can have a duration equal to two fifths of the frame time. In other examples, the duration of an image scanning signal can be equal to, longer than, or shorter than the duration of a black-inserting scanning signal.

It is to be further understood that even though numerous characteristics and advantages of preferred embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An active matrix liquid crystal display (LCD), comprising:
a plurality of scanning lines that are parallel to each other and that each extend along a first direction;
a plurality of signal lines that are parallel to each other and that each extend along a second direction orthogonal to the first direction;
a plurality of thin film transistors (TFTs) each provided in the vicinity of a respective point of intersection of the scanning lines and the signal lines;
a plurality of scanning line driving circuits for providing a plurality of scanning signal groups to the scanning lines, each of the scanning signal groups including an image scanning signal and a black-inserting scanning signal;
a plurality of signal line driving circuits for providing gradation voltage data to the signal lines when an image scanning signal is provided to the scanning lines by the scanning line driving circuits; and
a plurality of black-inserting circuits for providing a high voltage corresponding to black image data to the signal lines when a black-inserting scanning signal is provided to the scanning lines by the scanning line driving circuits.

2. The active matrix LCD as claimed in claim 1, further comprising a timing control circuit used to provide clock signals having a steady period.

3. The active matrix LCD as claimed in claim 1, wherein both the image scanning signal and the black-inserting scanning signal are pulse signals.

4. The active matrix LCD as claimed in claim 2, wherein a duration of each image scanning signal plus a duration of each black-inserting scanning signal is equal to one clock period.

5. The active matrix LCD as claimed in claim 4, wherein the duration of each image scanning signal is equal to the duration of each black-inserting scanning signal.

6. The active matrix LCD as claimed in claim 4, wherein the duration of each image scanning signal is longer than the duration of each black-inserting scanning signal.

7. The active matrix LCD as claimed in claim 4, wherein the duration of each image scanning signal is shorter than the duration of each black-inserting scanning signal.

8. The active matrix LCD as claimed in claim 1, wherein each of the scanning signal groups has a duration equal to half of a frame time.

9. The active matrix LCD as claimed in claim 1, wherein each of the scanning signal groups has a duration equal to two fifths of a frame time.
